(19) United States
(12) Patent Application Publication
(10) Pub. No.: US 2018/0046547 A1
(43) Pub. Date: Feb. 15, 2018

(54) STORAGE CONTAINER DS UNIT REASSIGNMENT BASED ON DYNAMIC PARAMETERS

(71) Applicant: International Business Machines Corporation, Armonk, NY (US)

(72) Inventors: S. Christopher Gladwin, Chicago, IL (US); Jason K. Resch, Chicago, IL (US); Gary W. Grube, Barrington Hills, IL (US); Timothy W. Markison, Mesa, AZ (US)

(21) Appl. No.: 15/797,745

(22) Filed: Oct. 30, 2017

Related U.S. Application Data
(63) Continuation-in-part of application No. 15/005,306, filed on Jan. 25, 2016.
Application No. 15/005,306 is a continuation of application No. 13/527,881, filed on Jun. 20, 2012, now Pat. No. 9,244,770.
(60) Provisional application No. 61/505,010, filed on Jul. 6, 2011.

(51) Int. Cl. G06F 11/10; G06F 3/06

(52) U.S. Cl. CPC G06F 11/1092; G06F 11/1084; G06F 3/064; G06F 3/0619; G06F 3/067; G06F 11/1096; G06F 2211/1028

(57) ABSTRACT

A dispersed storage network (DSN) includes storage units storing dispersed error-encoded data slices, and logically grouped into a container served by a computing device configured as a container controller. A method for use in such a DSN, includes obtaining by the container controller, a container status of the container, the container status including a status indicator associated with a first storage unit included in the container. The container controller determines whether the container status compares favorably to a status threshold, and in response to an unfavorable comparison, determines a data slice to be migrated from the first storage unit. The method further includes determining, at the container controller, a second storage unit to receive the data slice to be migrated, and facilitating, at the container controller, migration of the data slice to be migrated from the first storage unit to the second storage unit.

### CROSS-REFERENCE TO RELATED APPLICATIONS

The present U.S. Utility patent application claims priority pursuant to 35 U.S.C. §120 as a continuation-in-part of U.S. Utility application Ser. No. 15/005,306, entitled “RESPONDING TO A MAINTENANCE FREE STORAGE CONTAINER SECURITY THREAT”, filed Jan. 25, 2016, which claims priority pursuant to 35 U.S.C. §120 as a continuation of U.S. Utility application Ser. No. 13/527,881, entitled “RESPONDING TO A MAINTENANCE FREE STORAGE CONTAINER SECURITY THREAT”, filed Jun. 20, 2012, now U.S. Pat. No. 9,244,770 issued on Jan. 26, 2016, which claims priority pursuant to 35 U.S.C. §119(e) to U.S. Provisional Application No. 61/505,010, entitled “OPTIMIZING A CONTAINER BASED DISPERSED STORAGE NETWORK”, filed Jul. 6, 2011, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

In some cases, individual storage devices, or in groups of storage devices, can malfunction, perform erratically, or be overloaded, possibly resulting in the need to obtain data that would otherwise be retrieved from the problem device, from another source. While various technologies exist to recover/rebuild data, or to obtain data from alternate sources, such technologies are reactive, rather than proactive.

Technologies for monitoring a storage device for potential problems, such as imminent failure, exist, but these technologies generally do little more than generate a maintenance notification for technicians to replace the failing device. Thus, current technologies do not provide an automated, proactive solution for ensuring that the data stored in a failing drive is never lost to begin with.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a dispersed storage network utilizing storage unit containers, in accordance with various embodiments of the present invention; and

FIG. 10 is a flowchart illustrating an example of migrating slices from one storage unit to another, in accordance with various embodiments of the present invention.

### DETAILED DESCRIPTION OF THE INVENTION

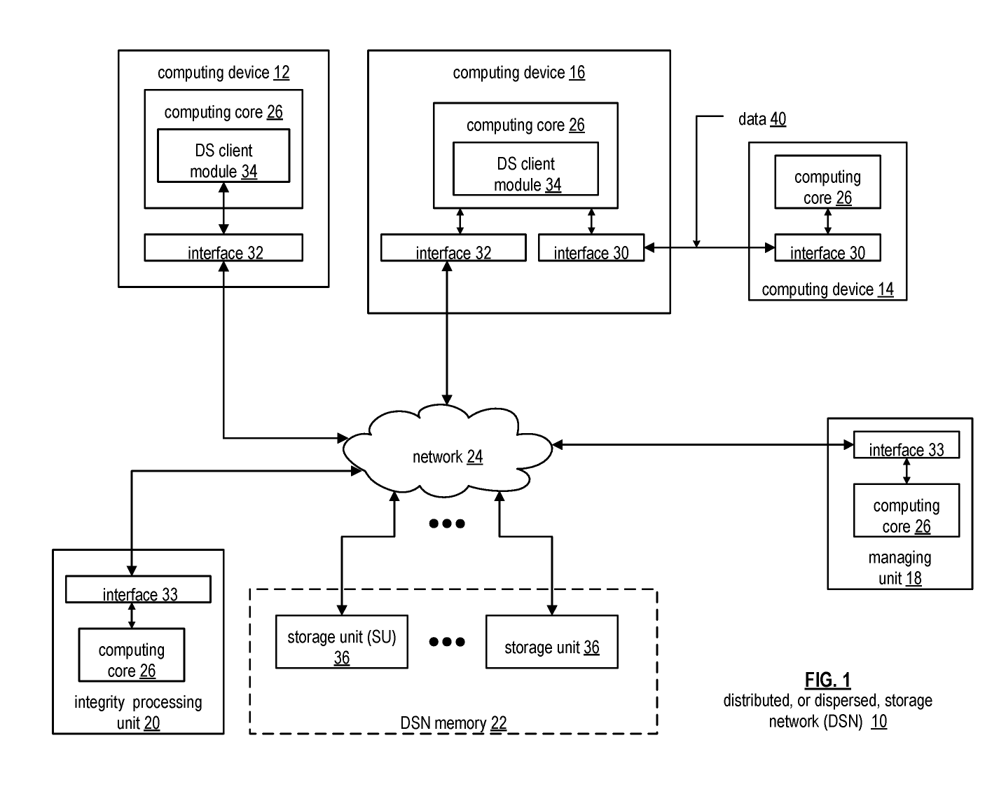

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

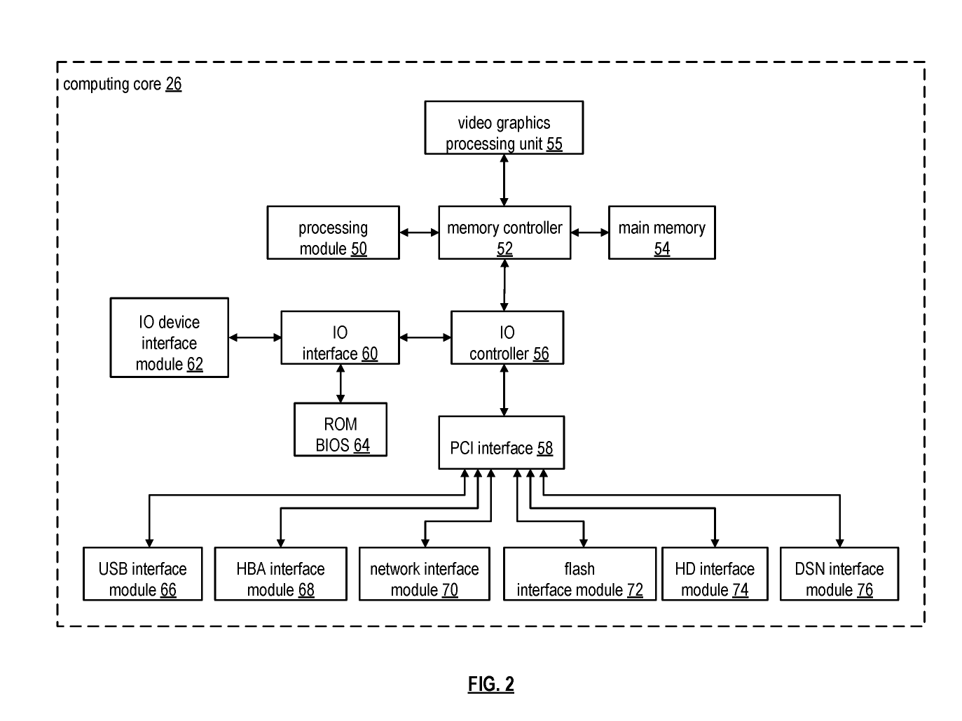

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

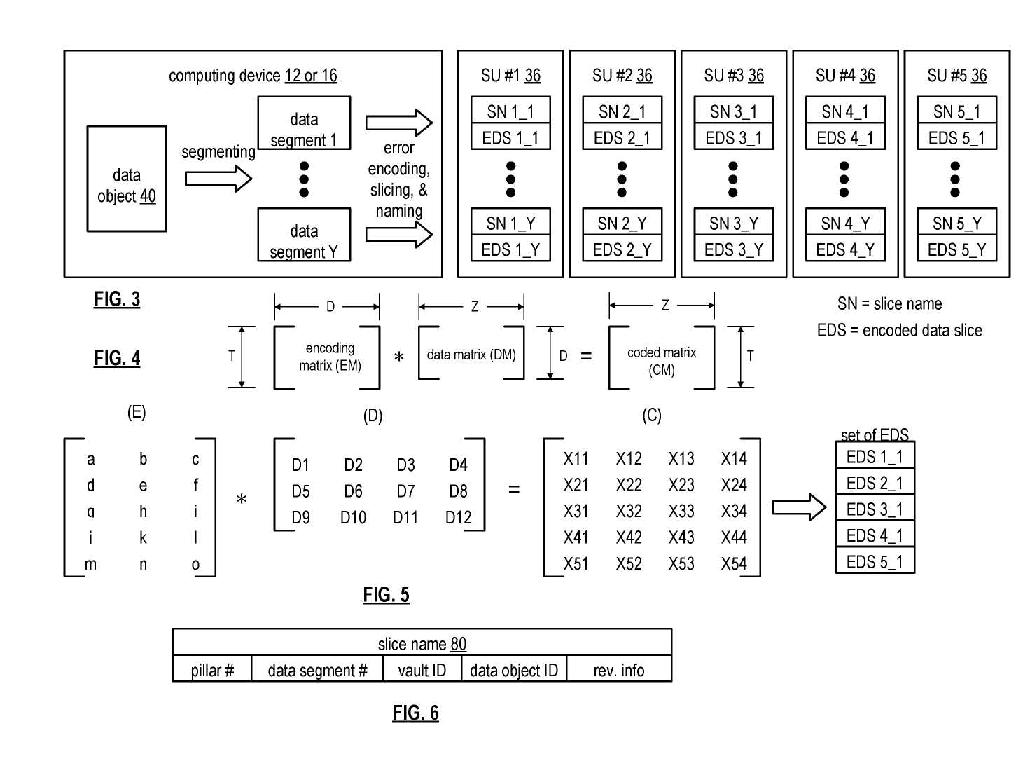

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an 10 interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

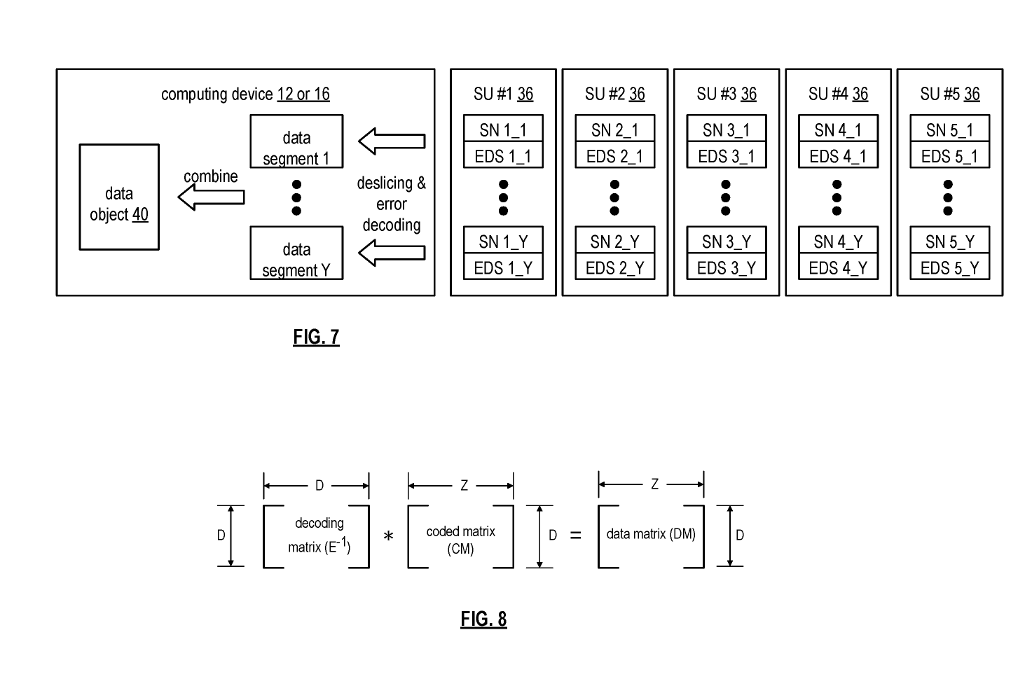

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

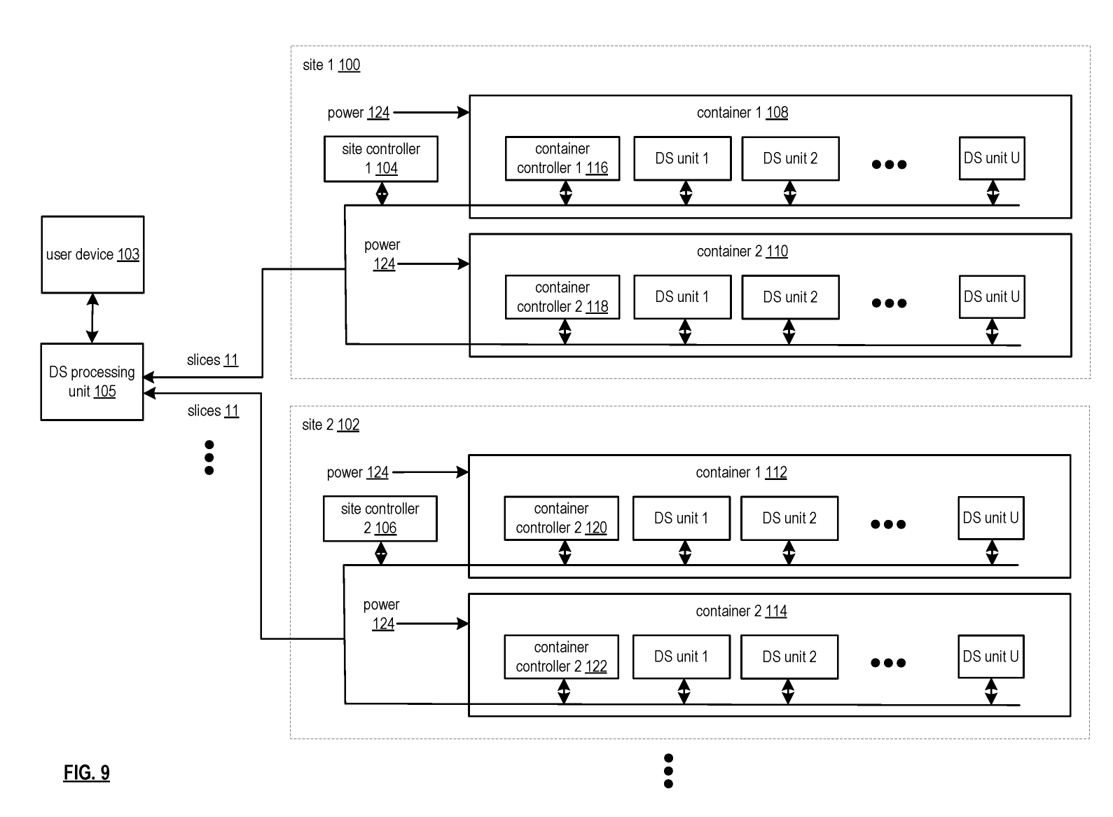

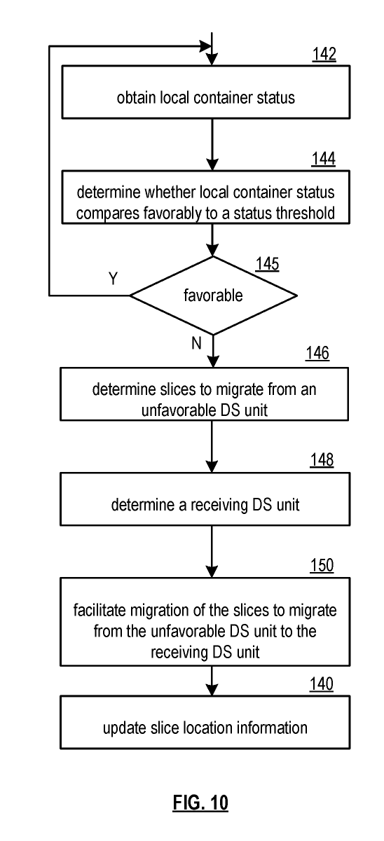

Referring next to FIGS. 9 and 10, A distributed storage network (DSN) utilizing a storage container approach will be discussed. In general, a container controller determines loading, performance, and environmental conditions of a plurality of distributed storage (DS) units within a container. The container controller facilitates reassignment of DS unit assignments and/or the migration of slices from a first DS unit to a second DS unit based on the loading, performance, and environmental conditions. For example, the container controller moves slices from a DS unit with a high temperature to a DS unit with a lower temperature. As another example, the container controller powers down or more DS units when an aggregate power usage of the container exceeds a power threshold. As yet another example, the container controller migrates slices from one DS unit to another based on memory device failures.

FIG. 9 is a schematic block diagram of an embodiment of a dispersed storage network (DSN) utilizing such distributed storage (DS) unit containers. Note that the DS units illustrated in FIG. 9 can correspond to instances of storage unit (SU) 36 as shown in FIG. 1. The system includes a user device 103 implemented using computer device 14 of FIG. 1, a dispersed storage (DS) processing unit 105 implemented using computing device 16 of FIG. 1, and a plurality of sites 100, 102. Each site of the plurality of sites 100, 102 may be located at different geographic locations providing geographic diversity. The sites provide a physical installation environment, required power, and network connectivity (e.g., wireline and/or wireless) to other sites of a dispersed storage network (DSN). Each site of the plurality of sites hosts one or more maintenance free containers of a plurality of containers 108-114 and each site hosts at least one site controller of a plurality of site controllers 104-106. For each site, the at least one site controller may be implemented as a separate computing unit (e.g., a server) or as a function within one or more of the one or more containers.

Each container (e.g., a shipping container, a box, a sealed environment, a tanker, a thermal control pool) of the one or more containers includes one or more of network connectivity, one or more DS units 1-U (e.g., storage servers), at least one container controller of a plurality of container controllers 116-122, environmental control (e.g., heating and cooling), and a power input 124. The at least one container controller may be implemented as a separate computing unit or as a function within the one or more DS units 1-U. For example, container 1 108 at site 1 100 includes a container controller 1 116 and DS units 1-U associated with container 1 108 and container 2 110 at site 1 100 includes a container controller 2 118 and DS units 1-U associated with container 2 110.

The at least one site controller assists in container operations associated with a common site. For example, site controller 1 104 receives an access request from DS processing unit 105 and facilitates access to the one or more containers 108-110 associated with site controller 1 104. As another example, site controller 1 104 facilitates migration of stored encoded data slices 11 from container 1 108 of site 1 100 to container 2 110 of site 1 100 based on migration criteria.

The at least one container controller assists in container operations associated with the at least one container controller. For example, container controller 2 122 of container 2 114 of site 2 102 receives an access request from DS processing unit 105 and facilitates access to the one or more DS units 1-U associated with the container controller 2 122. As another example, container controller 1 120 of container 1 112 of site 2 102 facilitates migration of stored encoded data slices 11 from DS unit 2 of container 1 112 of site 2 102 to DS unit 10 of container 1 112 of site 2 102 based on migration criteria.

In an example of storing data, encoded data slices 11 associated with each pillar of a pillar width number of a set of encoded data slices are stored within a common container. For instance, the DS processing unit 105 dispersed storage error encodes data to produce a plurality of sets of encoded data slices 11, wherein each set of the plurality of sets of encoded data slices includes four pillars of encoded data slices when a pillar width is four. Next, the DS processing unit 105 facilitate storage of each set of four encoded data slices of the plurality of sets of encoded data slices 11 in DS units 1-4 of container 1 108 at site 1 100. In an example of retrieving the data, the DS processing unit 105 facilitates retrieval of at least three encoded data slices 11 from DS units 1-4 of container 1 108 at site 1 100 when a decode threshold is three. In an example of rebuilding an encoded data slice of a set of the plurality of sets of encoded data slices, container controller 1 116 at site 1 100 retrieves at least three encoded data slices 11 from DS units 1-4 of container 1 108 at site 1 100 and dispersed storage error decodes the at least three encoded data slices to reproduce a data segment associated with an encoded data slice to be rebuilt. Next, the container controller 1 116 at site 1 100 dispersed storage error encodes the data segment to reproduce the data slice to be rebuilt.

In another example storing data, encoded data slices associated with each pillar of the pillar with number of the set of encode slices are stored within two or more containers of a common site. For instance, a DS processing unit 105 facilitates storage of two encoded data slices of each set of four encoded data slices of the plurality of sets of encoded data slices 11 in DS units 1-2 of container 1 112 at site 2 102 and facilitates storage of a remaining two encoded data slices of each set of four encoded data slices of the plurality of sets of encoded data slices in DS units 1-2 of container 2 114 at site 2 102.

In an example of retrieving the data, the DS processing unit 105 facilitates retrieval of at least three encoded data slices 11 from DS units 1-2 of container 1 112 at site 2 102 and DS units 1-2 of container 2 114 at site 2 102. In an example of rebuilding an encoded data slice of a set of the plurality of sets of encoded data slices 11, site controller 2 106 at site 2 102 retrieves at least three encoded data slices 11 from DS units 1-2 of container 1 112 at site 2 102 and DS units 1-2 of container 2 114 at site 2 102 and dispersed storage error decodes the at least three encoded data slices to reproduce a data segment associated with an encoded data slice to be rebuilt. Next, the site controller 2 106 at site 2 102 dispersed storage error encodes the data segment to reproduce the data slice to be rebuilt.

FIG. 10 is a flowchart illustrating an example of migrating slices from one storage unit to another, which may or may not be part of different container controlled by different container controllers. The method begins at step 142 where a processing module (e.g., a container controller) obtains a status of a local container. The local container status includes a dispersed storage (DS) unit status indicator for one more DS units of a common container serviced by the container controller, or by another container controller. The DS unit status indicator includes one or more of a DS unit loading indicator, a DS unit performance indicator, and a DS unit environmental indicator. The obtaining may be based on one or more of a query, a test, sensor data, a record lookup, or an error message.

The method continues at step 144 where the processing module determines whether the local container status compares favorably to a status threshold. The status threshold includes one or more of a loading threshold, a performance threshold, and an environmental indicator threshold. The determination performed at step 144 includes determining whether a DS unit status associated with each DS unit of a common container compares favorably to the status threshold. In some embodiments the DS unit status can be compared in the aggregate. For example, the processing module determines that the local container status compares unfavorably to the status threshold when a DS unit environmental indicator indicates that a DS unit temperature is greater than a high temperature environmental indicator threshold. As another example, the processing module determines that the local container status compares unfavorably to the status threshold when a DS unit performance indicator is less than the performance threshold. As yet another example, the processing module determines that the local container status compares unfavorably to the status threshold when a DS unit available memory indicator is less than an available memory threshold. As illustrated by block 145, the method loops back to step 142 when the processing module determines that the local container status compares favorably to the status threshold. The method continues to step 146 when the processing module determines that the local container status compares unfavorably to the status threshold.

The method continues at step 146 where the processing module determines slices to migrate from an unfavorable DS unit associated with the unfavorable comparison. The determining identifies slice names of a subset of a plurality of slices stored in the DS unit based on one or more of the local container status, a nature of the unfavorable comparison, and migration table. For example, the processing module can determine to move all slices of the plurality of slices when a nature of the unfavorable comparison is a DS unit of high temperature environmental indicator. As another example, the processing module can determine to move half of the plurality of slices when a nature of the unfavorable comparison is a high DS unit loading indicator.

The method continues at step 148 where the processing module determines a receiving DS unit. The determining includes selecting a DS unit associated with a local container status that compares favorably to a receiving local container threshold. For example, the processing module selects a DS unit that has favorable loading capacity when the nature of the unfavorable comparison is a high DS unit loading indicator. In some embodiments, a container controller associated with the unfavorable DS unit can send an individual or broadcast query to one or more other site controllers to request status information about DS units associated with another storage container, or about the other storage container in the aggregate. In other embodiments, the container controller associated with the unfavorable DS unit can send an individual or broadcast query to one or more other DS units included in the same container. In some implementations, status information for one or more containers is updated, periodically or otherwise, without requiring the container controller to query for the information.

Additionally, in some embodiments selection of a DS unit can include determining whether the container associated with a receiving DS unit compares favorably, in the aggregate, to the container associated with the unfavorable DS unit. In some implementations, for example, loading of multiple DS units associated with a container, loading of a site controller associated with that container, aggregate power usage of the DS units associated with the container, or the like can be used to determine an acceptable receiving DS unit.

The method continues at step 150 where the processing module facilitates migration of the slices to migrate from the unfavorable DS unit to the receiving DS unit. The facilitation includes at least one of sending a migration request to the unfavorable DS unit, wherein the request includes the slice names to migrate, and retrieving the slices to migrate from the unfavorable DS unit and sending the slices to migrate to one of the receiving DS unit and a container controller associated with the receiving DS unit. The method continues with step 140, where the processing module updates slice location information such that the slices are associated with the receiving DS unit and disassociated from the unfavorable DS unit.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for use in a dispersed storage network including a plurality of storage units storing dispersed error-encoded data slices, the storage units logically grouped into a container served by a computing device configured as a container controller, the method comprising:
obtaining, by the container controller, a container status of the container, the container status including a status indicator associated with a first storage unit included in the container;
determining, at the container controller, whether the container status compares favorably to a status threshold;
in response to an unfavorable comparison, determining, at the container controller, a data slice to be migrated from the first storage unit;
determining, at the container controller, a second storage unit to receive the data slice to be migrated; and
facilitating, at the container controller, migration of the data slice to be migrated from the first storage unit to the second storage unit.

2. The method of claim 1, wherein:
at least one of the plurality of storage units is configured as the container controller.

3. The method of claim 1, wherein the dispersed storage network includes a plurality of containers, each of the plurality of containers associated with a local container controller, the method further comprising:
migrating the data slice to be migrated from a first storage unit included in a first container, to a second storage unit included in a different container.

4. The method of claim 3, further comprising:
migrating the data slice to be migrated from the first storage unit to another storage unit included in the same container as the first storage unit.

5. The method of claim 1, wherein determining the second storage unit to receive the data slice to be migrated includes:
selecting a second storage unit having at least one of:
a more favorable operating temperature than the first storage unit;
a more favorable loading than the first storage unit;
a more favorable power utilization than the first storage unit;
a more favorable performance than the first storage unit; or
more available memory than the first storage unit.

6. The method of claim 1, wherein determining a data slice to be migrated includes:
determining whether to migrate all, or only some, data slices currently stored in the first storage unit, based on the container status.

7. The method of claim 6, wherein determining whether to migrate all, or only some, data slices includes:
determining to migrate all data slices stored in the first storage unit in response to an unfavorable comparison to a temperature threshold.

8. A container controller for use in a dispersed storage network including a plurality of storage units storing dispersed error-encoded data slices, the storage units logically grouped into a container served by the container controller, the container controller comprising:
a processor;
memory coupled to the processor;
a program of instructions configured to be stored in the memory and executed by the processor, the program of instructions including:
at least one instruction to obtain a container status of the container, the container status including a status indicator associated with a first storage unit included in the container;
at least one instruction to determine whether the container status compares favorably to a status threshold;
at least one instruction to determine, in response to an unfavorable comparison, a data slice to be migrated from the first storage unit;
at least one instruction to determine a second storage unit to receive the data slice to be migrated; and
at least one instruction to facilitate migration of the data slice to be migrated from the first storage unit to the second storage unit.

9. The container controller of claim 8, wherein:
at least one of the plurality of storage units is configured as the container controller.

10. The container controller of claim 8, wherein the dispersed storage network includes a plurality of containers, each of the plurality of containers associated with a local container controller, the program of instructions including:
at least one instruction to migrate the data slice to be migrated from a first storage unit included in a first container, to a second storage unit included in a different container.

11. The container controller of claim 10, further comprising:
at least one instruction to migrate the data slice to be migrated from the first storage unit to another storage unit included in the same container as the first storage unit.

12. The container controller of claim 8, wherein the at least one instruction to determine a second storage unit to receive the data slice to be migrated includes:
at least one instruction to select a second storage unit having at least one of:
a more favorable operating temperature than the first storage unit;
a more favorable loading than the first storage unit;
a more favorable power utilization than the first storage unit;
a more favorable performance than the first storage unit; or
more available memory than the first storage unit.

13. The container controller of claim 8, wherein the at least one instruction to determine a data slice to be migrated from the first storage unit includes:
at least one instruction to determine whether to migrate all, or only some, data slices currently stored in the first storage unit based on the container status.

14. The container controller of claim 13, wherein the at least one instruction to determine whether to migrate all, or only some, data slices includes:
at least one instruction to determine to migrate all data slices stored in the first storage unit in response to an unfavorable comparison to a temperature threshold.

15. A dispersed storage network comprising:
a plurality of storage units storing dispersed error-encoded data slices, the plurality of storage units logically grouped into a plurality of containers;
a plurality of container controllers, each of the plurality of container controllers coupled to a particular containers, at least one of the plurality of container controllers including a processor and associated memory configured to:
obtain a container status of the container, the container status including a status indicator associated with a first storage unit included in the container;
determine whether the container status compares favorably to a status threshold;
in response to an unfavorable comparison, determine a data slice to be migrated from the first storage unit;
determine a second storage unit to receive the data slice to be migrated; and
facilitate migration of the data slice to be migrated from the first storage unit to the second storage unit.

16. The dispersed storage network of claim 15, wherein:
at least one of the plurality of storage units includes a container controller.

17. The dispersed storage network of claim 15, wherein the at least one of the plurality of container controllers is further configured to:
migrate the data slice to be migrated from a first storage unit included in a first container, to a second storage unit included in a different container.

18. The dispersed storage network of claim 17, wherein the at least one of the plurality of container controllers is further configured to:
migrate the data slice to be migrated from the first storage unit to another storage unit included in the same container as the first storage unit.

19. The dispersed storage network of claim 15, wherein the at least one of the plurality of container controllers is further configured to:
determining the second storage unit to receive the data slice to be migrated by selecting a second storage unit having at least one of:
a more favorable operating temperature than the first storage unit;
a more favorable loading than the first storage unit;
a more favorable power utilization than the first storage unit;
a more favorable performance than the first storage unit; or
more available memory than the first storage unit.

20. The dispersed storage network of claim 15, wherein the at least one of the plurality of container controllers is further configured to:
determine whether to migrate all, or only some, data slices currently stored in the first storage unit based on the container status.
